(19) United States
(12) Patent Application Publication
(10) Pub. No.: US 2009/0191014 A1
(43) Pub. Date: Jul. 30, 2009

(54) Devices for the drilling of lenses and finishing assembly screws and associates method

(76) Inventors: Frédéric Dupuy, Taverny (FR); Abdel Malek Boussalem, Fillieres (FR)

Correspondence Address: YOUNG & THOMPSON, 209 Madison Street, Suite 500, ALEXANDRIA, VA, 22314, US

(21) Appl. No.: 10/585,445

(22) PCT Filed: Jan. 7, 2005
(86) PCT No.: PCT/FR2005/000025

§ 371 Date: Jul. 7, 2006

(30) Foreign Application Priority Data
Jan. 8, 2004 (FR) 0400132

(51) Int. Cl. B23B 1/00; B23B 5/16; B24B 9/14; B23Q 16/00; B23B 49/00

(52) U.S. Cl. 408/1 R; 409/140; 408/97

(57) ABSTRACT

A device for piercing (1) glasses, particularly optical glasses, includes at least one machining tool (5) for piercing a glass and which is actuated by at least one drive motor (10), a member (2) for supporting at least one glass and at least one element for conveying the glass into the working area of the above-mentioned machine tool (5), and an element for treating and visualizing data relating to the glass, characterized in that it includes an element for indicating the distance of an edge of the glass in relation to a reference point in order to position the machine tool (5) opposite the location of the piercing which is to be carried out. A method for piercing and a device and a method for finishing screws which are cut during the assembly of pierced-glass-based spectacles, are also disclosed.

This invention relates to the field of devices for the drilling of lenses and their drilling methods. This invention relates more particularly to the drilling of optical lenses based on organic polymers such as polycarbonate, which, combined with a frame constituted by two arms and a bridge, for example of titanium, constitute light and virtually invisible spectacles.

At present several methods exist for assembling drilled lenses, in particular disclosed by the patents FR 2835930, U.S. Pat. No. 6,502,940, U.S. Pat. No. 6,315,409 or U.S. Pat. No. 6,588,894.

A standard method for producing drilled lenses comprises the following chronological steps:
placing of an order with a producer of lenses showing the correction prescribed for the patient, the lens supplied being presented in the shape of a disc,
centring and placement of an oriented self-adhesive support which allows it to be fixed in a determined guide mark, in the machines where it will undergo the remainder of the production method,
adjustment of the lens to the required shape by grinding,
drilling and production of notches adapted to the frame chosen by the patient,
assembly by screws and nuts, clips, gluing or another method,
in the case of assembly by screws, cutting of the part of the screws protruding from the nut using cutting nippers, then deburring and smoothing using a file or another tool, to provide a clean finish, but also to prevent snagging of the cloth used to clean the spectacles.

The difficulties in the method set out above reside in the following two points:
precise drilling/grooving which is guaranteed, reproducible, easy (meticulous and painstaking work, often with losses),
deburring and finishing of the screw (meticulous work, often with losses).

In order to envisage solutions to these difficulties, the prior art already discloses:
manual tooling, non-specific to the operation: risks of considerable losses, imprecise and painstaking work, difficulty in carrying out certain operations such as producing notches etc.
manual tooling specific to this type of assembly, illustrated by the patent FR FR2816069, and patent application WO99/37449. The risk of losses and the painstaking aspect of the work are improved, but remain all the same, to the point where some opticians are discouraged from selling this type of spectacles, or, if they do, they sub-contract their assembly,
automated tools, constructed starting with machine-tools (3-axis digital milling machine) driven by suitable software, such as that described in the U.S. Pat. No. 54,020,607. The Patent Application WO 03/043781 is also known, which relates to a device making it possible to carry out machining operations of one or more spectacle lenses. This device comprises means allowing the mounting of one or more work tool(s) performing at least the shaping and/or drilling and/or polishing of the lens(es), these operations being carried using one or more drilling and/or shaping tool(s) comprising one or more cutting diameters, means ensuring the three-dimensional movement of the machining tools, allowing the tool to follow the work trajectory (trajectories) necessary for the execution of its functions, and one or more clamping elements which each hold a single spectacle lens. These improved systems constitute 3- or 4-axis generic machines which are bulky, expensive and difficult to use, requiring a specialist work force or a significant period of apprenticeship.
finally, producers (“Briot”, “Weco” and “Nidek”) now offer grinding machines incorporating a computerized drilling option, but not suitable for opticians already equipped with a grinding machine.

The prior art also discloses a method which consists of having on the one hand software which defines the work to be carried out on lenses and, on the other hand, a computer-controlled machine which carries out this work. The Patent Application WO 01/29609 illustrates in this respect a method of drilling cut-out optical lenses in order to produce so-called “rimless” spectacles the arms and the bridge of which are fixed directly to said lenses, said method being characterized in that it comprises steps consisting of defining on a computer at least one isostatic drilling plane of the arms, defining on a computer at least one isostatic drilling plane of the nose bridge, combining said drilling planes and a virtual lens template on a computer by superimposing said drilling planes on said template, storing the information relating to the drilling planes and their combination with said lens template, then transmitting said information to at least one digitally controlled drilling unit in order to drill said cut-out lenses corresponding to said template according to said information. The major drawback of this approach resides in the fact that it requires a precise knowledge of the shape of the lenses to be drilled, and hence a complex control of the shapes of the lenses according to the makes and models. Moreover, this approach makes it difficult to alter the lens shape according to the wishes or needs of a patient that are possibly linked to his physiology.

This invention aims to remedy the drawbacks of the prior art by proposing a less complex and less expensive machine which is totally dedicated to this drilling and notching work. The first innovation introduced by this invention is to bring independence from the shape of the lens by using only its edge, which makes it possible to manage without the creation of a complex database combining frames and lens shapes, and which also makes it possible to select from different makes and to assemble any shape of lens whatever on any frame whatever, or also to freely alter the shape of the lenses according to the patient's needs.

The second innovation proposed in this invention, still aimed at simplifying the use and reducing the cost of the machine, involves, as is desirable most of the time, automatically and mechanically ensuring orthogonality between the drilling tool and the drilled surface, with neither operator intervention nor entry of parameters linked to the curvature of the lens. This does not of course prevent other drilling angles from being chosen when required by the type of frame.

Finally, for easy, perfect and completely safe finishing of the assembly screws after they have been cut, a method and manner of carrying it out are proposed.

The machine can moreover be equipped with a simple loading/conveying device capable of presenting several preloaded lenses in turn in front of the drilling tool.

As an alternative to the loading conveyor, it is possible to envisage another graduated embodiment of the drilling device in which there is no loader/conveyor but one or more simple drilling modules each having one operative on a fixed lens, only capable of pivoting and turning about itself. This embodiment has simplicity and cost advantages. In this case, in order to still work on several lenses at the same time, the control of several drilling modules can advantageously be concentrated in a single computer, with a single database.

In order to do this, this invention relates to a device for the drilling of lenses, in particular optical lenses, comprising at least one machining tool for drilling a lens, actuated by at least one driving motor, a means supporting at least one lens and at least one means of introducing said lens into the working zone of the abovementioned machining tool, a means of processing and displaying the data relating to said lens, characterized in that it comprises a means for giving the distance from one edge of the lens to a reference point, in order to position the machining tool opposite the location of the drilling to be carried out.

According to an embodiment of the invention, the abovementioned means is a tracer fastened onto the edge of the lens.

Advantageously, the device according to the invention comprises an automatic means suitable for ensuring the perpendicularity of the surface of the zone of the lens to be drilled relative to the machining tool, the abovementioned means of support being inclinable.

According to an embodiment of the invention, the abovementioned means is a support means resting on the lens.

Advantageously, the device of the invention comprises at least one database comprising a plurality of frame models, simply constituted by two arms and a bridge, and the positioning for each frame of the drillings and notchings to be carried out relative to the edge of said lens.

Advantageously, the assembly method for drilled lenses according to the invention uses a spectacle-assembly screw finishing tool, fastened onto the nuts, for deburring and levelling off the screws using a drill, milling cutter or other turning tool.

Within this framework, the finishing tool can moreover comprise at least one removable guide, i.e. one interchangeable according to the dimensions of the means of fixing the screw (nut or device comparable to a nut), resting on the lens, intended to surround the abovementioned means in order to guide the above-mentioned tool towards the end of the screw.

Moreover, in order to obtain several types of finish, namely more or less concave, more or less convex, or also with a particular complex profile, the turning tool (drill, milling cutter or other tool which can serve for the finishing) can advantageously be interchangeable.

Advantageously, the drilling device according to the invention comprises a reading means and a coding means combined with the elements of the frame to define the drillings and/or notchings relative to the drilling axis and the edge of the lens.

According to one possibility offered by the invention, the device comprises a lens loader/conveyer so as to accelerate the rate of processing (drilling and finishing of the screws) of the lenses.

In optical use, the lens is of the organic lens type, for example polycarbonate-based, or any other type of lens having the same mechanical properties vis-à-vis drilling and the same qualities for making an optical lens from same.

Before starting the drilling, the choice of the type of frame can be made in different ways:
choice from a database comprising all of the frames used by the optician,
manual collection of drilling and notching data for the frame; which can be added to the database, for a frame not yet featuring therein.
reading of the drilling data on a device accompanying the frame and optionally supplied with it by its supplier, such as for example a magnetic label combined with the frame, containing all the data relating to the drilling and notching for this frame.

Moreover, in the case of a “mix and match” selection (combination of a frame with a lens shape other than that initially provided for by the frame designer), a statistical intuitive positioning of the drilling axis, i.e. the line linking the arms and the bridge to the lenses, is proposed by the device according to the invention, which makes it possible to automatically give a location for the holes and notches to be produced. The operator can alter this intuitive positioning as needed, if he considers it necessary to take account of certain features, for example the customer's physical features or wishes. In the case of certain frames, there can be several different drilling axes for the bridge and for the arms.

This invention also relates to a method for drilling lenses using the device according to any one of the preceding claims, comprising a step of placing at least one lens on at least one support, a step of introducing the drilling tool into the drilling axis, a step of drilling the lens, characterized in that it comprises a step of detecting at least part of the contours, or of the edges, of said lens.

Advantageously, the method according to the invention optionally comprises a step of recording said contours, or said edges, of the lens.

Advantageously, the method according to the invention comprises a step of automatic fastening of the lens so as to present the surface of the drilling position of the lens perpendicular to the drilling tool.

According to one possibility offered by the invention, the method according to the invention comprises a prior step of defining at least one linear drilling axis proposed to the user.

In the same manner, the method according to the invention can comprise a prior step of reading a coding means defining the location and dimensions of the drillings and the notchings relative to the edge of the lens and to the drilling axis.

According to one possibility offered by the invention, the method of the invention comprises a step of automatic proposal to the operator of an intuitive positioning of the drilling axis based on rules, pre-recorded in the processing means, associated with each of the frames.

By means of the invention, apart from the advantages previously mentioned regarding simplicity of use and cost, the space required for such a dedicated drilling device is particularly small. The present solution is simple, while if necessary automatically carrying out a drilling, orthogonal to the drilling surface. Moreover, it allows an intuitive positioning of the arms and nose relative to the lens, which is generally optimum, whilst leaving the operator free to adapt it to the patient. The device according to the invention also incorporates a solution for finishing the assembly screws. Finally, in order to still further simplify this operation of assembly of drilled lenses with frames, the invention proposes the use of a principle of labelling the frames which is comprehensible to a machine, making it possible to automate control of the drilling machine.

The invention will be better understood with the help of the description, given hereafter purely by way of explanation, of an embodiment of the invention with reference to the attached figures:

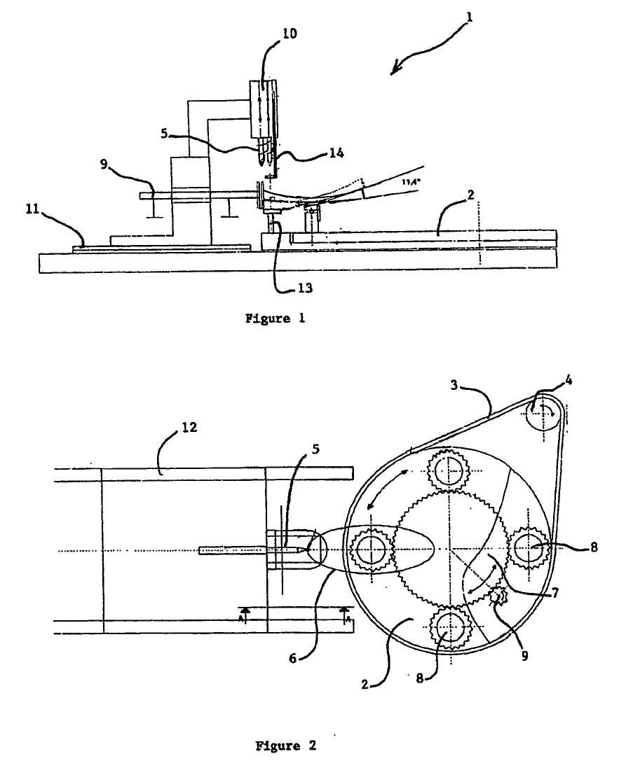

FIG. 1 illustrates a sectional view of a drilling device according to the invention;

FIG. 2 illustrates a diagrammatic view of the device represented in FIG. 1, the machining tool being visible according to a vertical section and the means of support and a lens being visible according to a view from above, and

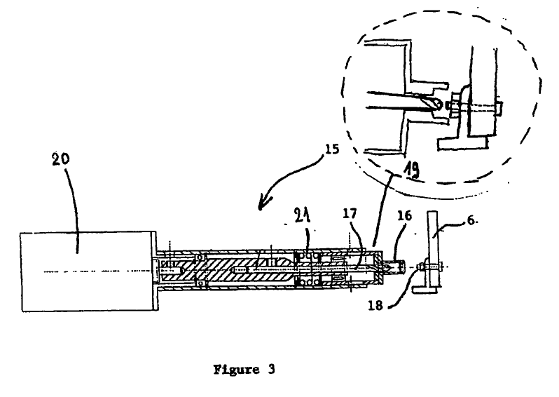

FIG. 3 illustrates a sectional view of the screw finishing tool.

According to the invention, illustrated in FIG. 1, the drilling device 1 comprises a means 2 supporting lenses, here consisting of a lens-dispensing tray. This circular tray 2, represented in FIGS. 1 and 2, is linked, by means of a contact strip 3, to a driving motor 4 in order to ensure its horizontal rotation, perpendicular to the axis of the drilling tool 5. The direction of rotation of the driving motor 4 and thus of the distributing tray 2 is left to the choice of the user.

The tray 2 dispensing lenses 6 comprises, in the example chosen in order to illustrate the invention, a large central toothed wheel 7 and four small toothed wheels 8. The teeth of the small toothed wheels 8 are in contact with the teeth of the large central toothed wheel 7 such that, when the large central toothed wheel 7 is in rotation, the latter rotates the small toothed wheels 8. A motor 9 drives the large toothed wheel 7. The small toothed wheels 8 each include supports for a lens 6 intended to be drilled, capable of inclining relative to the vertical, for example by being mounted on gimbals. The lenses 6, by means of oriented self-adhesive supports (as described in the prior art), rest on these toothed wheels 8.

The tray 2 distributing lenses 6 includes a basic element in the device of the present invention: a tracer 9. The tracer 9, placed on a fixed support, comprises a sliding end, which has the function of remaining permanently in contact with the edge of the lens 6 to be drilled and giving its distance from a fixed point. This allows the machining tool 5 to work at a given distance from the edge of the lens 6, without having to worry about the shape of the lens 6.

For the operator's greater convenience, without his interacting with the machine, the contour, or the shape, of the lens 6 can be recorded by means of the tracer linked to the data-processing means, not shown in the attached figures, then be displayed, the drilling of the lens 6 can then commence, after the user has chosen his frame type.

From this aspect, the drilling device 1 according to the invention also comprises a motor 10 driving the tool machining the lens, to ensure its rotation at a speed adjusted according to the characteristics of the material to be drilled. The armature 12 supporting the motor 10 is capable of translating horizontally on its base in order to bring the tool towards the lens to be drilled or notched. The motor 10 is mounted on its support 12, so as to be able to translate vertically, in order to drill or notch the lens 6.

As illustrated in FIG. 1, the lens 6 is mounted on a dial which can be left free or locked in the vertical position. The inclination is 11.4° in the example of FIG. 1. Moreover, on the means of support 2 there is a fixed support element 13, here consisting of a protuberance extending in a T-shape, the upper end of which allows a part of the lens 6 to rest. This protuberance, when situated at the same level as the support of the lens 6, ensures drilling orthogonal to the drilled surface. For a different drilling angle, it is sufficient, manually or optionally automatically, to raise or lower this level. Drilling at 90° relative to the axis of the lens 6 takes place automatically by locking the dial in the vertical position.

In addition to these different elements, the drilling tool comprises a support means 14, the length of which is variable, fixed indirectly or directly to the drilling tool 5 in order to come to rest close to the surface of the lens-drilling location so as to easily orient this surface perpendicular to the drilling tool 5. This mechanical solution for the orientation of the lens 6 perpendicular to the drilling tool 5 has the clear advantage of a particularly significant cost saving, whilst retaining full control of the orientation of the lens 6.

The method of drilling the lens 6 in the present invention, with the device described previously, is as follows:

1. The lenses 6 are fixed, by means of a self-adhesive support, to the articulated rotary supports 8. The combination of the rotational movements of the distributing tray 2, calculated by the processing means, and the drive of the lens 6 makes it possible to move, by the control of the processing means to the motors of the distributing tray 4 and the large toothed wheel 9, and place the lens 6 in any position relative to the tool 5, in the horizontal plane;

2. The lens 6 is brought opposite the tool 5, i.e. into its working zone, and the tracer 9, a complete rotation of the support makes it possible to capture the shape by means of the tracer 9. The operator displays the shape of the lens 6 on the screen;

3. The operator chooses a frame model (arms and bridge) from a database, or reads its magnetic code using a suitable reader. Combined with a statistical intuitive positioning of the line linking the arms and the bridge on the lenses, this makes it possible to automatically propose a location for the holes and notches to be produced. The operator can, if needed, alter this intuitive positioning if he deems it necessary in order to take account of certain features, for example the client's physique or wishes. The operator can also, instead of choosing a frame from a database, himself have available a series of holes and notches to be produced;

4. Inclination of the lens 6 in order to ensure the orthogonality of the drilling surface zone relative to the pin, this being achieved by means of the articulation of the support 8 and by pressing on the lever 14 until the lens 6 comes into contact with the support 13;

5. Drilling of the lens 6 by translation, then lowering of the broaching tool;

6. Steps 1 to 4 are repeated as many times as there are pairs of lenses;

7. Raising of the broaching tool and release of the lens 6 from the inclination.

If the operations to be carried out require a change of tool 5, a second cycle can be carried out after having changed the tool 5.

In an alternative, more elaborate, embodiment the broaching tool 5 is capable of pivoting by 180°, in order to be able to work on the lower face of the lens 6. This operation may be required for certain frames with countersunk screws on the front face.

A code which can be used for recording the drilling and notching information for a frame is for example the following:
unique frame reference (not indispensable, to be defined by the profession),
information for an arm,
number of holes,
diameter, distance (horizontal) from the edge of the lens, vertical distance (positive or negative) relative to the arms-bridge drilling line,
repetition of the above structure for each hole,
number of notches,
horizontal (or vertical distance from the edge of the lens, diameter, length of the notch,
repetition of the above structure for each notch,
information for one side of the bridge,
same structure as above for an arm.

As spectacles are symmetrical, the information for the other arm and for the other side of the bridge is identical and does not therefore need to be coded.

FIG. 3 illustrates a possible embodiment of the device for finishing the screws. This device is constituted by a sleeve incorporating an electric motor 20, which rotates a levelling tool 17, fixed or optionally interchangeable, of the flat milling cutter type, for a flat finish of the screw, or of the V-shaped milling cutter type, for a convex finish of the screw, or a drill, for a concave finish of the screw, or also a specific tool intended to obtain a particular profile on the screw 18.

For optimum precision of the finishing operation, it is necessary to guide the levelling tool in a very precise manner towards the centre of the screw. This is the role played by the guiding end-piece 16, which is essentially a cylindrical tube in which the levelling tool slides, in a narrowly adjusted manner. At its end, the shape of the guiding end-piece allows it to surround the nut 18 as close as possible to its periphery, and to rest on its surface, but without ever risking touching the lens 6, either with the end-piece itself, or with the levelling device that it is protecting. FIG. 3 shows this form in detail, number 19.

The levelling tool 17 is held fixed onto the shaft of the motor situated in the sleeve 20 of the finishing device, and is protected in a tube integral with the sleeve of the tool. The guiding end-piece 16 is situated at the end of this tube in which it can slide between two fixed positions, whilst being returned by a spring 21 to its extreme position, the screw being at a distance from the levelling tool. The other extreme position serves as a stop and to provide security for the lens by defining the most concave finishing possible of the screw (without risking damaging the lens with the levelling tool). Thus, the guiding end-piece being placed on the nut, pressure on the finishing device held by its sleeve will have the effect of causing the end to slide in the body and thus move the levelling tool closer to the screw, until it is in contact, then machining of the former, by the latter which is rotated by means of the electric motor.

In the presented embodiment of the screw-finishing device, the rotation of the tool 17 is started by simple pressure on the sleeve 20 using a switch judiciously placed on the latter. The sleeve contains an electric motor directly driving the tool 17. The path traveled by the guide in the body is defined such that that at the end of the path the desired finishing depth is obtained, and in any case so as to prevent the tool 17 being pushed too deep into the screw and risking damage to the lens.

In the field of mechanical optics, experience shows that three different guiding end-pieces with one end having a circular section make it possible to cover the whole range of screws and nuts currently used in this field. In this field the nuts used have perimeters which fit within circles with diameters ranging from 2.2 mm to 2.8 mm. Therefore in order to cover the whole range of existing nuts, we use 3 end-pieces having ends with different 3 diameters: 2.2 mm-2.5 mm and 2.8 mm. The distance to which the nut penetrates inside the guiding end-piece before coming to rest is defined according to the diameter of the nut, the type of tool used and the type of finish desired. For example in the case of a concave finish produced using a drill, the depths increase with the diameter of the nut and of the screw, and thus the diameter of the end of the guiding end-piece. The greater the diameter of the nut, and thus the wider the diameter of the screw, the more deeply the levelling tool, which in this case is a drill much wider than the screw, penetrates into the screw. As the position of the levelling tool is fixed, the depth in relation to the nut is varied by varying the depth to which the nut penetrates into the guiding end-piece. For a concave finish in the field of mechanical optics, a drill with a diameter of 2 mm is suitable for the whole range of screws currently used.

This device for finishing the screws 15 serves to finish the screws once the latter are fixed to the lenses 6 for the fixing of the arms, and the nose, and cut using cutting nippers, for example. In fact, it is necessary for the optician to sell finished spectacles, i.e. the ends, or tails, of the screws 18 of which have been filed, or leveled, not only out of aesthetic considerations but also in order not to tear or damage the cloth or wipe used for cleaning the lenses 6.

Advantageously the finishing device can be mounted on a fixed support for example of the vertical drill support type, in order to lighten and/or systematize the screw finishing operation in an assembly workshop. There is no need here to go into details regarding the production of such a support, many realizations of which already exist.

The screw-finishing device as described above is wholly suitable for the finishing of screws in the assembly of spectacles based on drilled frames, but can very easily be transposed to be used in other technical fields, where the screws and nuts are for example larger or smaller, or also where the guiding for the finishing is carried out with an object surrounding the screw which can be something other than a nut, or even on the screw itself, or also in the case where a rivet is used rather than a screw. In this latter case, the finishing relates to the rivet.

The invention is described above by way of example. It is understood that a person skilled in the art is capable of producing different variants of the invention without thereby going beyond the scope of the patent.

1-17. (canceled)

18. A tool for finishing spectacle-assembly-screw, fastened with a guiding end-piece onto assembling nuts, for deburring and levelling off assembling screws in a sure and precise manner using a drill, a milling cutter or a similar tool, optionally specific.

19. The tool according to claim 18, characterized in that it comprises at least one replaceable guiding end-piece, i.e. one interchangeable according to the dimensions of the means of fixing the screw, resting on the lens (6), intended to surround the abovementioned means in order to guide the abovementioned tool towards the end of the screw.

20. The tool according to claims 18, characterized in that the tool used (bell-shaped cutter, flat milling cutter or drill, specific tool) is interchangeable according to the form of the desired finishing.

21. The tool according to claim 18, characterized in that it is mounted on a fixed support, the finishing operation being controlled by a handle, a lever or a knob or any other means similar to the latter.

22. A Device for the drilling (1) of lenses, in particular optical lenses, comprising at least one machining tool (5) for drilling a lens (6), actuated by at least one driving motor (10), a means (2, 8) for supporting at least one lens (6) and at least one means (3, 4) for introducing said lens (6) into the working zone of the abovementioned machining tool (5), a means for processing and displaying the data relating to said lens (6), characterized in that it further comprises a means for giving the distance from one edge of the lens (6) to a reference point, in order to position the machining tool (5) opposite the location of the drilling to be carried out.

23. Device according to claim 22, characterized in that the abovementioned means is a tracer fastened to the edge of the lens (6).

24. Device according to claim 22, characterized in that it further comprises an automatic means (14) capable of ensuring the perpendicularity of the surface of the zone of the lens (6) to be drilled relative to the machining tool (5), the abovementioned means of support (2, 8) being inclinable.

25. Device according to claim 24, characterized in that the abovementioned means consists of a support means coming to rest on the lens (6).

26. Device according to claim 22, characterized in that it further comprises at least one database comprising a plurality of frame models, constituted simply by two arms and a bridge, and of the positioning for each frame of the drillings and notchings to be carried out relative to the edge of said lens (6).

27. Device according to claim 22, characterized in that it further comprises a loader/conveyer of lenses.

28. Device according to claim 22, characterized in that it further comprises a reading means and a coding means combined with the elements of the frame to define the drillings and/or notchings relative to the drilling axis and the edge of the lens (6).

29. A Method for the drilling of lenses, comprising a step of placing at least one lens (6) on at least one support (2, 8), a step of introducing the drilling tool (5) into the drilling axis, and a step of drilling the lens (6), characterized in that it also comprises a step of detecting at least part of the contours, or of the edges, of said lens (6) by assessing the distance of said contours or edges relative to a reference point.

30. Method according to claim 29, characterized in that it further comprises a step of recording said contours, or said edges, of the lens (6).

31. Method according to claim 29, characterized in that it further comprises a step of fastening the lens (6) so as to present the drilling position surface of the lens (6) perpendicular to the drilling tool (5).

32. Method according to claim 29, characterized in that it further comprises a prior step of defining at least one linear drilling axis proposed to the user.

33. Method according to claim 29, characterized in that it further comprises a prior step of reading an coding means defining the position and the dimensions of the drillings and of the notchings relative to the edge of the lens (6) and to the drilling axis.

34. Method according to claim 29, characterized in that it further comprises an automatic step of proposing to the operator an intuitive positioning of the drilling axis based on rules, pre-recorded in the abovementioned processing means, associated with each of the frames.
